(19) United States
(12) Patent Application Publication
(10) Pub. No.: US 2005/0203999 A1
(43) Pub. Date: Sep. 15, 2005

(54) System and method for rule-pen based conversations in synchronous collaborative environment

(75) Inventors: Naveenkumar Vishwanath Muguda, Cary, NC (US); Shrinivas Shridhar Kulkarni, Bangalore (IN)

Correspondence Address: VAN LEEUWEN & VAN LEEUWEN, P.O. BOX 90609, AUSTIN, TX, 78709-0609, US

(73) Assignee: International Business Machines Corporation, Armonk, NY (US)

(21) Appl. No.: 10/798,128

(22) Filed: Mar. 11, 2004

(51) Int. Cl. G06F 15/16

(52) U.S. Cl. 709/205

(57) ABSTRACT

A system and method for rule-pen based conversations in a synchronous collaborative environment is presented. A plurality of users participates in an online collaborative discussion. A first participant has a comment, such as a question, and does not know the other participants' skill sets. The first participant selects a rule pen that includes an associated rule. The first participant's client includes the rule and a comment in a message, and sends the message to a server. The server identifies qualified participants that meet the rule criteria, and forwards the message to the qualified participants. The qualified participants may modify the rule, and respond to the message accordingly.

### BACKGROUND OF THE INVENTION

1. Technical Field

The present invention relates in general to a system and method for rule-pen based conversations in a synchronous collaborative environment. More particularly, the present invention relates to a system and method for a participant in a collaborative discussion to intuitively engage in conversations with other participants based upon rule criteria.

2. Description of the Related Art

With the onset of advanced technology, online collaboration has become increasingly feasible. Online collaboration systems support groups of people that are engaged in a common task (or goal) by providing an interface to a shared environment. For example, users may use a distributed presentation tool on each of their client computers, such as Lotus e-Meeting or Windows NetMeeting, in order for the users to collaborate on a particular topic. As businesses become more global, and as businesses cut expenses, online collaboration has become a popular mechanism for users who are located at different geographic locations to participate in a meeting.

Participants of an online collaboration session are people with different skill sets, different time zones, and whose willingness to help other participants varies. A challenge found with existing art is that if, during a presentation, a first participant wishes to discuss a particular aspect of the presentation, the first participant is challenged in identifying other participants from which to receive assistance. The first participant may not know the other participants' skill sets and, therefore, the first participant's option to receive assistance is to disrupt the presentation by interrupting the presenter. For example, a participant may have a question regarding a portion of a presentation that corresponds to Java bean creation. In this example, the participant may not know which other participants are qualified to answer his question regarding Java bean creation.

A user may explicitly invoke a collaborative session with various participants. However, a challenge found with this approach is that the user is not able to intuitively reference portions of the presentation, such as figures and diagrams. In addition, a user may find it difficult to manage multiple conversations (i.e. collaborative sessions), and also may not being interested in each conversation that is occurring.

What is needed, therefore, is a system and method for a participant to intuitively collaborate with other participants based upon the other participants' particular information, such as their skill sets.

### SUMMARY

It has been discovered that the aforementioned challenges are resolved by using a rule pen to identify discussion participants that meet particular criteria, and send a message to the identified discussion participants that includes a rule and a comment. A discussion participant selects a rule pen that includes an associated rule. The discussion participant's client includes the rule and a comment in a message, and sends the message to a server. The server identifies other participants that meet the rule criteria, and forwards the message to the identified participants. Upon receipt, the identified participants may respond to the message. In addition, the identified participants may export the rule, modify the rule, and associate the modified rule to a new rule pen for use with subsequent messages.

A server supports a collaborative discussion, such as a distributed presentation, between a plurality of clients. For example, users may use a distributed presentation tool on each of their clients, such as Lotus e-Meeting or Windows NetMeeting, in order for the users to collaborate on a particular topic.

A first user initiates the discussion and has his client send session content to the server through a computer network, such as the Internet. The server identifies users that are participating in the distributed presentation, and sends the session content to the users' clients. For example, a company's division may be participating in a distributed presentation whereby users that correspond to each of the clients belong to the division.

A second user reviews the session content and has a comment, such as a question, regarding the session content. For example, the second user may have a particular question regarding EJB (Enterprise Java Bean) technology and does not know which other participant to ask the question. The second user creates a rule pen, associates a rule to the rule pen, and includes one or more rule sentences to correspond with the rule. A rule sentence may be atomic or complex, and may include terms, constants, connectives and functions. The second user's client includes the rule and the comment in a message, and sends the message to the server through the computer network.

The server receives the message and extracts the rule from the message. The server parses the rule and uses a look-up table to identify participants implied in the rule. In one embodiment, the server may access an online company directory to identify discussion participants that correspond to the rule.

Once the server is finished identifying participants that correspond to the rule, the server sends the message to the identified participants, whereby the identified participants may respond to the message (i.e. answer a question). In addition, an identified participant may export the rule, modify the rule (i.e. add, remove, or modify rule sentences) in order to create a new rule pen for use with subsequent messages. When more than one participant exports a rule pen, these participants may have a conversation which is confined to the participants identified by the rule associated with the rule pen that is used to send messages.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a plurality of clients collaborating in a distributed presentation and one of the clients sending a message that includes a rule to a server;

FIG. 2A is a user interface window showing an example of software code corresponding to creating a rule pen;

FIG. 2B is a participant attribute table that includes a plurality of participant information entries;

FIG. 3 is a high level flow chart showing steps taken in a server sending a distributed presentation to a client and receiving a message from the client that includes a rule;

FIG. 4 is a flowchart showing steps taken in a client selecting a rule pen to include in a message;

FIG. 5 is a flowchart showing steps taken in a server identifying one or more participants based upon a rule;

FIG. 6 is a flowchart showing steps taken in a recipient client receiving and responding to a message; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

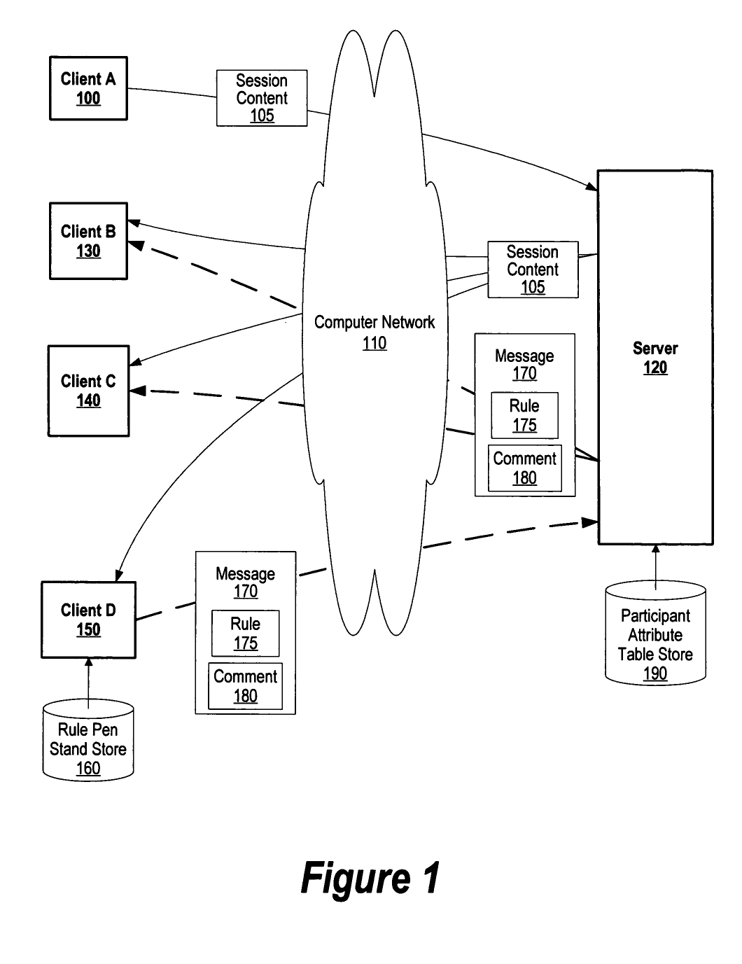

FIG. 1 is a diagram showing a plurality of clients collaborating in a distributed presentation and one of the clients sending a message that includes a rule to a server. Server 120 supports a collaborative discussion, such as a distributed presentation, between client A 100, client B 130, client C 140, and client D 150. For example, users may use a distributed presentation tool on each of the clients, such as Lotus e-Meeting or Windows NetMeeting, in order for the users to collaborate on a particular topic.

Client A 100 initiates the discussion and sends session content 105 to server 120 through computer network 110, such as the Internet. Server 120 identifies the users that are participating in the distributed presentation, and sends session content 105 to client B 130, client C 140, and client D 150. For example, a company's division may be participating in a distributed presentation whereby users that correspond to each of the clients are part of the division.

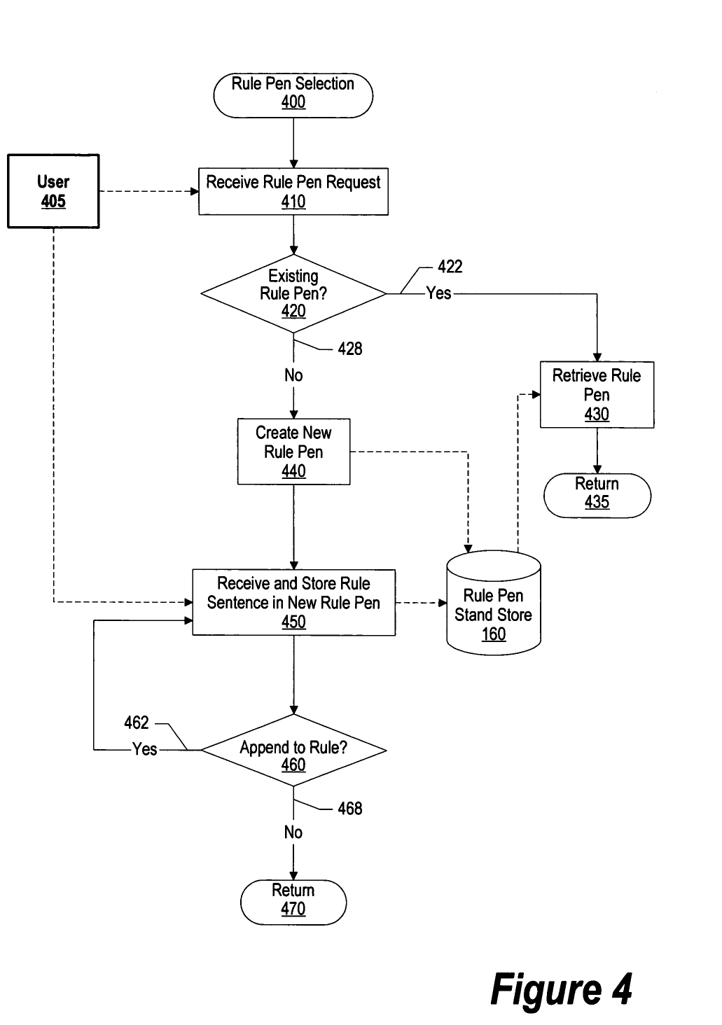

Client D 150's user reviews session content 105 and has a comment, such as a question, regarding session content 105. Client D 150's user creates a rule pen and stores it in rule pen stand store 160 (see FIG. 4 and corresponding text for further details regarding rule pen creation). Rule pen stand store 160 may be stored on a nonvolatile storage area, such as a computer hard drive. Client D 150's user then associates a rule with the rule pen and includes one or more rule sentences to correspond with the rule. A rule sentence may be atomic or complex, and may include terms, constants, connectives and functions. Client D 150 then includes the rule (e.g. rule 175), along with a comment that is generated by client D 150's user (e.g. comment 180), in message 170. Client D 150 (e.g. the sending client) sends message 170 to server 120 through computer network 110.

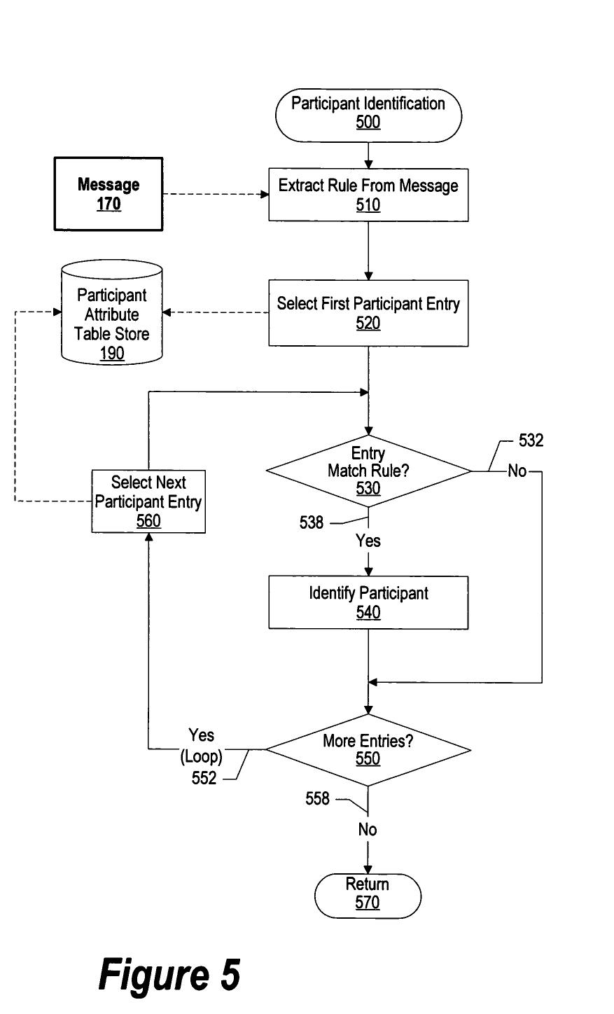

Server 120 receives message 170, and extracts rule 175. The server parses rule 175 and uses a table located in participant attribute table store 190 to identify participants that correspond to the rule sentences included in rule 175. In one embodiment, server 120 may access other repositories, such as an online company directory or the Internet, in order to identify participants (see FIG. 5 and corresponding text for further details regarding participant identification).

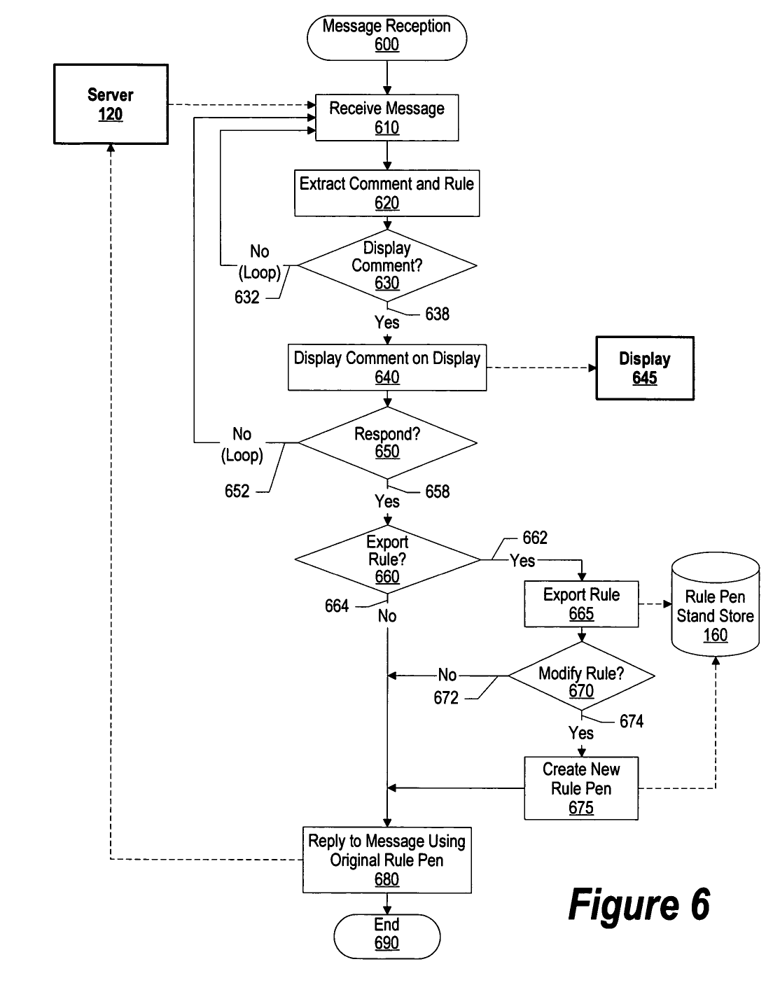

Once server 120 is finished identifying participants that correspond to rule 175, server 120 sends message 170 to the identified participants. The example shown in FIG. 1 shows that server 120 sends message 170 to client B 130 and client C 140 through computer network 110. Once a recipient client receives the message, and its user reviews the message, the user may respond to the message (see FIG. 6 and corresponding text for further details regarding message response details).

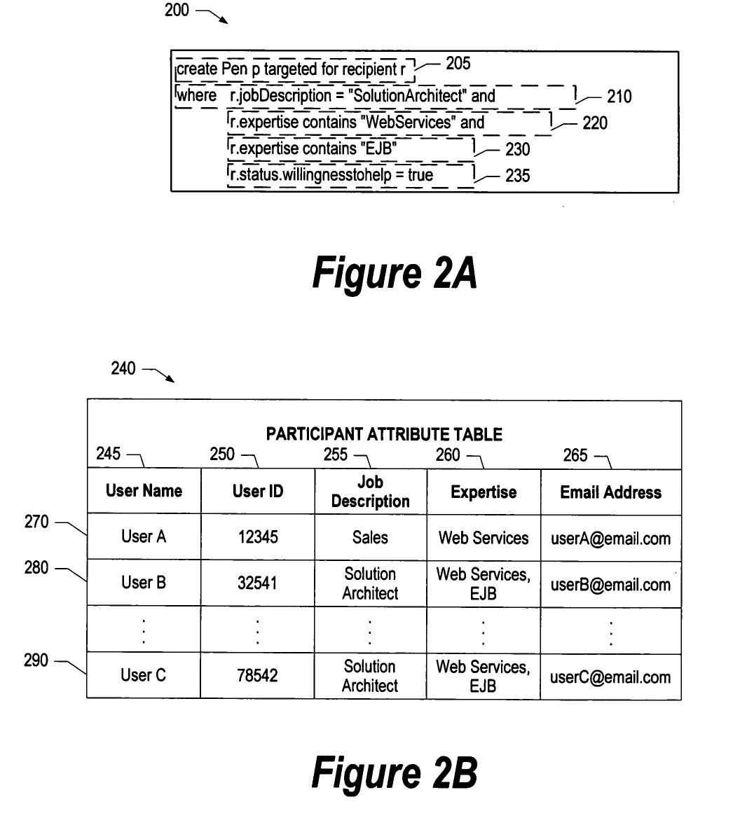

FIG. 2A is a user interface window showing an example of software code corresponding to creating a rule pen. Window 200 includes lines 205 through 230. Line 205 shows that rule pen “p” is targeted for recipients “r”, whereby a recipient “r” has participant attributes that meet the rule sentence criteria included in lines 210 through 230.

Line 210 is a rule sentence that includes a criterion for a recipient to have a job description of “Solution Architect.” Line 220 is a rule sentence that includes a criterion for a recipient to an expertise of “Web Services.” Line 230 is a rule sentence that includes a criterion for a recipient to have an additional expertise of “EJB.” And, line 235 is a rule sentence that includes a criterion for a recipient to be willing to help other participants. When a server receives a message that includes the rule sentences that are shown in window 200, the server identifies one or more participants whose job description is a solution architect, has expertise in web services and EJB, and is willing to help other participants (see FIG. 5 and corresponding text for further details regarding participant identification).

FIG. 2B is a participant attribute table that includes a plurality of participant entries. Participant attribute table store 240 includes a plurality of participant entries, each of which corresponds to participants in a collaborative discussion. The example in FIG. 2B shows that each participant entry includes five participant attributes which are shown in columns 245 through 265. A server may use this information, as well as other information (i.e. participant willingness to help, etc.) to identify participants to forward a corresponding message.

Column 245 includes a list of user names that correspond to participants involved in a collaborative discussion. Column 250 includes a list of user identifiers that correspond to the user names that are included in column 245. Column 255 includes a list of job descriptions that correspond to the participants that are involved in the collaborative discussion. For example, line 270 shows that “user A” has a job description of “Sales.” Column 260 includes a list of expertise that correspond to each collaborative discussion participant. For example, lines 280 and 290 show participant entries whose expertise are “Web Services” and “EJB.” And, column 265 includes a list of email addresses that correspond to each collaborative discussion participant. In one embodiment, a server may access the participant attribute table, or a different database, to identify participants that are willing to assist other participants with questions and/or comments corresponding to a presentation.

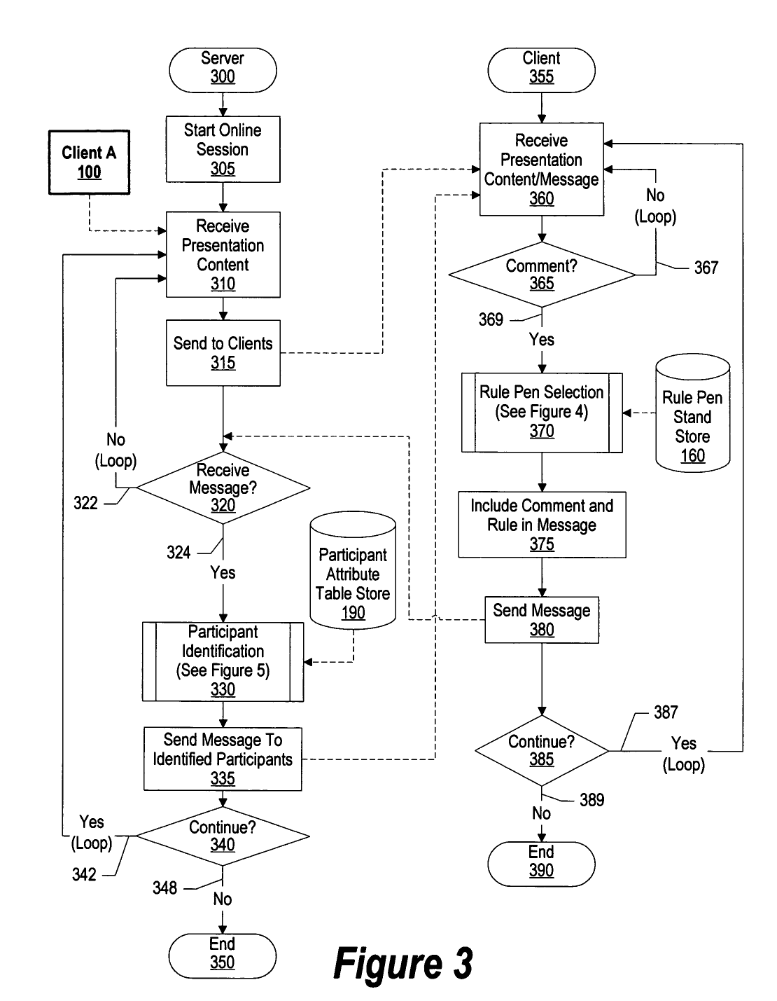

FIG. 3 is a high level flow chart showing steps taken in a server sending a distributed presentation to a client and receiving a message from the client that includes a rule. Server processing commences at 300, whereupon the server invokes a distributed presentation at step 305. For example, users may use a distributed presentation tool, such as Lotus e-Meeting or Windows NetMeeting, in order for the users that are geographically separated to visually collaborate on a particular topic.

Processing receives presentation content from client A 100 at step 310. Client A 100 is the same as that shown in FIG. 1 whose user may be the leader of the distributed presentation. Processing sends the presentation to clients that are part of the distributed presentation at step 315. For example, a software department may be participating in the distributed presentation which is discussing projects for the upcoming quarter.

Client processing commences at 355, whereupon the client receives the presentation content at step 360. Using the example described above, the client's user may be in the software department that is participating in the distributed presentation. The client may also receive a message from other clients that correspond to the presentation (see below for further details). A determination is made as to whether the user wishes to comment on the presentation content (decision 365). For example, the user may have a question regarding a particular portion of the presentation.

If the user does not wish to comment on the presentation content, decision 365 branches to “No” branch 367 which loops back to receive more presentation content. This looping continues until the user wishes to comment on presentation content, at which point decision 365 branches to “Yes” branch 369. The user selects an existing rule pen or creates a new rule pen in rule pen stand store 160. The rule pen has an associated rule that includes one or more rule sentences (pre-defined process block 370, see FIG. 4 and corresponding text for further details). Rule pen stand store 160 is the same as that shown in FIG. 1. The client's user generates a comment, and the client includes the comment, along with the selected rule, in a message at step 375. The client then sends the message to the server at step 380.

A determination is made as to whether the client should continue participating in the distributed presentation (decision 385). If the client should continue participating, decision 385 branches to “Yes” branch 387 which loops back to participate in the distributed presentation. This looping continues until the client stops participating in the distributed presentation, at which point decision 385 branches to “No” branch 389 whereupon client processing ends at 390.

During the distributed presentation, the server makes a determination as to whether it receives a client message that corresponds to the distributed presentation (decision 320). If the server does not receive a client message, decision 320 branches to “No” branch 322 which loops back to process the distributed presentation. This looping continues until the server receives a client message, at which point decision 320 branches to “Yes” branch 324 whereupon the server identifies one or more participants that meet particular rule criteria that is included in the message (pre-defined process block 330, see FIG. 5 and corresponding text for further details). The server uses a table located in participant attribute table store 190 during the participant identification process. Participant table attribute store 190 is the same as that shown in FIG. 1 and may be stored on a nonvolatile storage area, such as a computer hard drive.

Once participants have been identified, the message is sent to one or more clients that correspond to the identified participants (step 335). A determination is made as to whether the server should continue processing the distributed presentation (decision 340). If the server should continue processing the distributed presentation, decision 340 branches to “Yes” branch 342 which loops back to process the distributed presentation. This looping continues until the server stops processing the distributed presentation, at which point decision 340 branches to “No” branch 348 whereupon server processing ends at 350.

FIG. 4 is a flowchart showing steps taken in a client selecting a rule pen to include in a message. The client's user, such as user 405, is involved in a collaborative discussion using the client. The client's user wishes to send a comment to discussion participants that meet certain rule sentence criteria (i.e. a particular skill set or specialty).

Rule pen processing commences at 400, whereupon the client receives a rule pen request from user 405 at step 410. A determination is made as to whether the rule pen request corresponds to an existing rule pen (decision 420). For example, user 405 may have previously created a rule pen that includes one or more rule sentences that correspond to user 405's current request. If user 405 wishes to use an existing rule pen, decision 420 branches to “Yes” branch 422 whereupon the client retrieves the rule pen from rule pen stand store 160 (step 430), and returns at 435 Rule pen stand store is the same as that shown in FIG. 1, and may be stored on a nonvolatile storage area, such as a computer hard drive.

On the other hand, if user 405's request does not correspond to an existing rule pen, decision 420 branches to “No” branch 428 whereupon the client creates a new rule pen in rule pen stand store 160 at step 440. The client receives a first rule sentence from user 405, and stores the rule sentence in the new rule pen (step 450). A rule sentence may be atomic or complex, and may include terms, constants, connectives and functions.

A determination is made as to whether user 405 wishes to append to the new rule (i.e. add more rule sentences) (decision 460). If user 405 wishes to append to the rule, decision 460 branches to “Yes” branch 462 which loops back to receive a second rule sentence from user 405, and stores the second rule sentence in the new rule pen. This looping continues until user 405 does not wish to add more rule sentences to the rule pen, at which point decision 460 branches to “No” branch 468 whereupon processing returns at 470.

FIG. 5 is a flowchart showing steps taken in a server identifying one or more participants based upon a rule. The server received a message from a client, such as message 170, whereby the message includes a comment and a rule. The rule includes one or more rule sentences which the server uses to identify valid participants for which to forward the message (see FIG. 1 and corresponding text for further details regarding message forwarding). Message 170 is the same as that shown in FIG. 1.

Server processing commences at 500, whereupon the server extracts the rule from message 170 at step 510. The server selects a first participant entry that is located in participant attribute store 190 at step 520. Participant attribute table store is the same as that shown in FIG. 1 and may be stored on a nonvolatile storage area, such as a computer hard drive. A determination is made as to whether the first participant entry matches the extracted rule (decision 530). For example, if the rule includes three rule sentences, the server determines whether the first participant entry matches each of the three rule sentences. If the first participant entry matches the extracted rule, decision 530 branches to “Yes” branch 538 whereupon the server identifies the participant that corresponds to the first participant entry (step 540). For example, the server may identify a user id that corresponds to the first participant entry and store the user id in a hash table for use in sending the message to recipient participants. On the other hand, if the first participant entry does not match the extracted rule, decision 530 branches to “No” branch 532 bypassing the participant identification step.

A determination is made as to whether there are more participant entries located in participant attribute table store 190 (decision 550). If there are more participant entries located in participant attribute table store 190, decision 550 branches to “Yes” branch 552 which loops back to select (step 560) and process the next participant entry. This looping continues until there are no more participant entries to process, at which point decision 550 branches to “No” branch 558 whereupon processing returns at 570.

FIG. 6 is a flowchart showing steps taken in a recipient client receiving and responding to a message. The recipient client is involved in a collaborative discussion. The recipient client's user was identified as meeting rule criteria corresponding to a message that was sent from another participant (see FIG. 5 and corresponding text for further details regarding participant identification steps).

Recipient client processing commences at 600, whereupon the client receives a message from server 120 at step 610. The message includes a comment and a rule, the rule including one or more rule sentences. Server 120 is the same as that shown in FIG. 1. The client extracts the comment from the message at step 620, and a determination is made as to whether to display the comment (decision 630). For example, a participant may configure his client to not display comments that correspond to a particular rule. If the client should not display the comment, decision 630 branches to “No” branch 632 which loops back to receive more messages. This looping continues until the client receives a message that it should display, at which point decision 630 branches to “Yes” branch 638.

The client displays the comment on display 645 for its user to view. The client may display the comment in the same display window as the one that displays the collaborative discussion. In addition, a participant may configure his screen to display comments based upon a subset of rule pens. For example, his screen may display comments in green that correspond to one rule pen, and may display comments in blue that correspond to another rule pen. A determination is made as to whether the client's user wishes to respond to the comment (decision 650). For example, the comment may be a question in which the client's user knows the answer. In this example, the client's user may wish to respond to the inquiring participant. If the client's user does not wish to respond to the comment, decision 650 branches to “No” branch 652 which loops back to receive more messages. This looping continues until the client's user wishes to respond to a comment, at which point decision 650 branches to “Yes” branch 658.

A determination is made as to whether the client's user wishes to export the rule (decision 660). The client's user may wish to export the rule (and the user-id of the message initiator) in order to generate a new rule pen and associate the rule to the new rule pen. In addition, the client's user may wish to relax or refine the rule by removing or adding rule sentences. If the user does not wish to export the rule, decision 660 branches to “No” branch 664 bypassing rule exporting steps. On the other hand, if the client's user wishes to export the rule, decision 660 branches to “Yes” branch 662 whereupon the client exports the rule and associates the rule with a rule pen that is located in rule pen stand store 160 (step 665). Rule pen stand store 160 is the same as that shown in FIG. 1 and may be stored on a nonvolatile storage area, such as a computer hard drive.

A determination is made as to whether the client's user wishes to modify the rule by adding or removing rule sentences (decision 670). If the client's user does not wish to modify the rule, decision 670 branches to “No” branch 672 bypassing rule modification steps. On the other hand, if the client's user wishes to modify the rule, decision 670 branches to “Yes” branch 674 whereupon the client receives input from the user, creates a new rule pen, and associates the modified rule to the new rule pen (step 675).

The client generates a reply and sends the reply to server 120 at step 680 using the original rule pen. The reply includes the original rule, as well as a response from the client's user, such as an answer to a question. Client processing ends at 690.

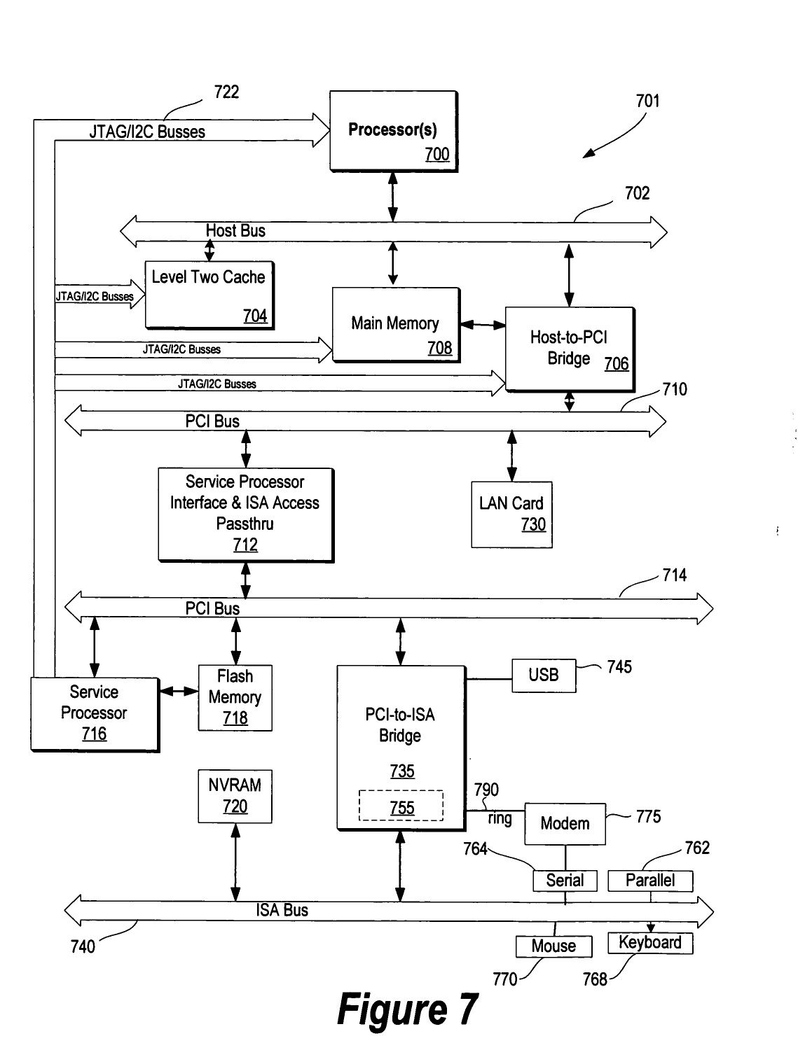

FIG. 7 illustrates information handling system 701 which is a simplified example of a computer system capable of performing the computing operations described herein. Computer system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer implemented method comprising:
invoking a collaborative discussion, the collaborative discussion including a plurality of users;
receiving a message from one of the plurality of users, the message including a rule;
identifying a subset of the plurality of users that correspond to the rule; and
forwarding the message to the identified users.

2. The method of claim 1 wherein the message includes a comment, and wherein recipient clients are adapted to display the comment in the same display window as the collaborative discussion, the recipient clients corresponding to the identified users.

3. The method of claim 2 wherein the comment is displayed using display attributes corresponding to a rule pen, the rule pen corresponding to the rule.

4. The method of claim 1 wherein the rule includes a plurality of rule sentences, the identifying further comprising:
selecting a participant entry, the participant entry corresponding to one of the plurality of users; and
matching each of the plurality of rule sentences with one or more user attributes that correspond to the selected participant entry.

5. The method of claim 4 wherein at least one of user attributes is selected from the group consisting of a job description and an expertise.

6. The method of claim 4 wherein at least one of the rule sentences includes a rule sentence value, and wherein the rule sentence value is selected from the group consisting of a term, a constant, a connective and a function.

7. The method of claim 1 wherein a recipient client is adapted to modify the rule, the modifying including changing the number of rule sentences that correspond to the rule, the recipient client corresponding to one of the identified users.

8. The method of claim 1 wherein the received message is sent from a sending client, the sending client adapted to select a rule pen from a rule pen stand, wherein the rule pen includes the rule.

9. An information handling system comprising:
one or more processors;
a memory accessible by the processors;
one or more nonvolatile storage devices accessible by the processors; and
a collaborative discussion tool that identifies a subset of a plurality of users that correspond to a rule, the collaborative discussion tool comprising software code effective to:
invoke a collaborative discussion, the collaborative discussion including the plurality of users;
receive a message from one of the plurality of users over a computer network, the message including the rule;
identify a subset of the plurality of users that correspond to the rule using user attributes that are located in one of the nonvolatile storage devices; and
forward the message to the identified users over the computer network.

10. The information handling system of claim 9 wherein the message includes a comment, and wherein recipient clients are adapted to display the comment in the same display window as the collaborative discussion, the recipient clients corresponding to the identified users.

11. The information handling system of claim 9 wherein the rule includes a plurality of rule sentences, wherein the software code is further effective to:
select a participant entry located in one of the nonvolatile storage devices, the participant entry corresponding to one of the plurality of users; and
match each of the plurality of rule sentences with one or more user attributes that correspond to the selected participant entry.

12. The information handling system of claim 11 wherein at least one of the rule sentences includes a rule sentence value, and wherein the rule sentence value is selected from the group consisting of a term, a constant, a connective and a function.

13. The information handling system of claim 9 wherein a recipient client is adapted to modify the rule, the modifying including adding or removing one or more rule sentences to or from the rule, the recipient client corresponding to one of the identified users.

14. The information handling system of claim 9 wherein the received message is sent from a sending client over the computer network, the sending client adapted to select a rule pen from a rule pen stand, wherein the rule pen includes the rule.

15. A program product comprising:
computer operable medium having computer program code, the computer program code being effective to:
invoke a collaborative discussion, the collaborative discussion including a plurality of users;
receive a message from one of the plurality of users, the message including a rule;
identify a subset of the plurality of users that correspond to the rule; and
forward the message to the identified users.

16. The program product of claim 15 wherein the message includes a comment, and wherein recipient clients are adapted to display the comment in the same display window as the collaborative discussion, the recipient clients corresponding to the identified users.

17. The program product of claim 15 wherein the rule includes a plurality of rule sentences, wherein the computer program code is further effective to:
select a participant entry, the participant entry corresponding to one of the plurality of users; and
match each of the plurality of rule sentences with one or more user attributes that correspond to the selected participant entry.

18. The program product of claim 17 wherein at least one of the rule sentences includes a rule sentence value, and wherein the rule sentence value is selected from the group consisting of a term, a constant, a connective and a function.

19. The program product of claim 15 wherein a recipient client is adapted to modify the rule, the modifying including changing the number of rule sentences that correspond to the rule, the recipient client corresponding to one of the identified users.

20. The program product of claim 15 wherein the received message is sent from a sending client, the sending client adapted to select a rule pen from a rule pen stand, wherein the rule pen includes the rule.

21. A computer implemented method comprising:
invoking a collaborative discussion, the collaborative discussion including a plurality of users;
receiving a message from one of the plurality of users, the message including a rule, wherein the rule includes a plurality of rule sentences;
selecting a participant entry, the participant entry corresponding to one of the plurality of users;
matching each of the plurality of rule sentences with one or more user attributes that correspond to the selected participant entry, the matching resulting in an identified user; and
forwarding the message to the identified user, wherein the message includes a comment, and wherein a recipient client is adapted to display the comment in the same display window as the collaborative discussion, the recipient client corresponding to the identified user.

22. A computer implemented method comprising:
invoking a collaborative discussion, the collaborative discussion including a plurality of users;
receiving a message from one of the plurality of users, the message including a plurality of rule sentences, wherein at least one of the rule sentences includes a rule sentence value, and wherein the rule sentence value is selected from the group consisting of a term, a constant, a connective and a function;
selecting a participant entry, the participant entry corresponding to one of the plurality of users;
matching each of the plurality of rule sentences with one or more user attributes that correspond to the selected participant entry, the matching resulting in an identified user; and
forwarding the message to the identified user.

23. An information handling system comprising:
one or more processors;
a memory accessible by the processors;
one or more nonvolatile storage devices accessible by the processors; and
a collaborative discussion tool that identifies a subset of a plurality of users that correspond to a rule, the collaborative discussion tool comprising software code effective to:
invoke a collaborative discussion, the collaborative discussion including a plurality of users;
receive a message from one of the plurality of users over a computer network, the message including a rule, wherein the rule includes a plurality of rule sentences;
select a participant entry from one of the nonvolatile storage devices, the participant entry corresponding to one of the plurality of users;
match each of the plurality of rule sentences with one or more user attributes that correspond to the selected participant entry, the matching resulting in an identified user; and
forward the message to the identified user over the computer network, wherein the message includes a comment, and wherein a recipient client is adapted to display the comment in the same display window as the collaborative discussion, the recipient client corresponding to the identified user.

24. A program product comprising:
computer operable medium having computer program code, the computer program code being effective to:
invoke a collaborative discussion, the collaborative discussion including a plurality of users;
receive a message from one of the plurality of users, the message including a rule, wherein the rule includes a plurality of rule sentences, the matching resulting in an identified user; and
forward the message to the identified user, wherein the message includes a comment, and wherein a recipient client is adapted to display the comment in the same display window as the collaborative discussion, the recipient client corresponding to the identified user.

25. A program product comprising:
computer operable medium having computer program code, the computer program code being effective to:
invoke a collaborative discussion, the collaborative discussion including a plurality of users;
receive a message from one of the plurality of users, the message including a plurality of rule sentences, wherein at least one of the rule sentences includes a rule sentence value, and wherein the rule sentence value is selected from the group consisting of a term, a constant, a connective and a function;
select a participant entry, the participant entry corresponding to one of the plurality of users;
match each of the plurality of rule sentences with one or more user attributes that correspond to the selected participant entry, the matching resulting in an identified user; and
forward the message to the identified user.
